(19) United States
(12) Patent Application Publication
(10) Pub. No.: US 2006/0027565 A1
(43) Pub. Date: Feb. 9, 2006

(54) Bathtub heater control apparatus and method

(76) Inventors: Patrick B. Healy, Costa Mesa, CA (US); Ron Le Force, Irvine, CA (US)

Correspondence Address: LEONARD TACHNER, A PROFESSIONAL LAW;CORPORATION, 17961 SKY PARK CIRCLE, SUITE 38-E, IRVINE, CA, 92614, US

(21) Appl. No.: 10/915,798

(22) Filed: Aug. 9, 2004

(51) Int. Cl. H05B 1/02

(52) U.S. Cl. 219/494

(57) ABSTRACT

An apparatus for bathtub heater control configured for two distinct functional operations; i.e., nominal control and safety oversight. The nominal control portion of the apparatus responds to normal operating parameters to heat the bathtub water to the desired temperature and to maintain it there within defined limits of precision. One aspect of this portion of the apparatus is proportionate temperature control. This feature employs heater power at less than full to achieve a fine degree of control at or near the desired temperature. Moreover, once the desired temperature is achieved, proportionate power of the heating element permits the maintenance of the water temperature at a more precise level. The safety oversight portion has the feature of operating only when power is applied to the heating element. This feature avoids unnecessary deactivation of the heater or heating element due to false sensing of an unsafe condition. The safety circuit preferably utilizes an internal fuse or circuit breaker requiring access to the heater itself before power can be restored to the heater. Separate temperature sensors are employed for nominal control and safety. The safety circuit requires that the temperatures sensed by these separate sensors be in agreement within a limited range.

### BACKGROUND OF THE INVENTION

1. Field of the Invention

The present invention relates generally to the control of spa and whirlpool bathtub heaters and more particularly to spa and whirlpool bathtub heater electronic control systems where circuits nominally control the heater and monitor heater safety for disabling the heater under unsafe conditions.

2. Background Art

Electronic control of heaters for spa bathtubs is a well-established art. Such control has the dual task of providing proper nominal control of the heating element while assuring the safety of the user. Proper nominal control translates to turning on the heating element as required to heat the bathtub water to the desired temperature as quickly and accurately as possible and then to maintain the desired temperature during bathtub use despite environmental cooling effects. The safety control of the heater disables the heater if and when nominal temperature control isn't working properly, such as when the water temperature exceeds a safe limit for some unknown reason.

Many patent disclosures for heater control systems designed to carry out these dual tasks have been issued. By way of example:

U.S. Pat. No. 4,421,270 to Raleigh et al discloses an electronic temperature control for spa heaters. They disclose narrow differential water temperature control which is achieved using amplifiers with differential inputs to control temperature to 1.5° F. Various safety features are disclosed including turning off the heater if the sensor fails and limiting the current and voltage to safe levels in the event of any component failure.

U.S. Pat. No. 5,550,753 to Tompkins et al discloses a microcomputer-based spa heater control system which calculates the rate of heating to avoid residual heating above the desired final temperature.

U.S. Pat. No. 5,932,127 to Maddox et al discloses use of the filter cycle clock to initiate a daily heating cycle. A safety circuit removes power to the heater if either the desired water temperature is reached or the heater high temp limit has been reached.

U.S. Pat. No. 6,084,218 to McDonough et al discloses a turn-off system which responds to the high temp limit and cannot be turned back on until system power is first removed entirely and then re-applied.

U.S. Pat. No. 6,355,913 to Authier et al discloses use of an infrared sensor for responding to infrared radiation emitted by the heating element during a hot pipe condition or a dry fire condition to turn off the heating element.

U.S. Pat. No. 6,590,188 to Cline et al discloses a bathtub heating control system having a microprocessor control circuit for controlling temperature and a separate independent safety circuit to disconnect high voltage power when water temperature exceeds a high limit.

U.S. Pat. Nos. 6,591,063 and 6,643,454 to Rochelle et al employs pressure switches to remove heater power when there is no or low water flow.

U.S. Pat. No. 6,646,237 to Liu discloses a water heater safety circuit which can detect dry heating by detecting changes in dynamic load-resistance values.

One of the principal disadvantages of these prior art controllers is that they respond to water temperature only, whether or not power is being applied to the heating element. Therefore, they will deactivate the heater even if there is no heater problem if the temperature of the water being added to the bathtub happens to exceed the high temperature limit. Thus, for example, if the water high temperature limit is set at 120° F. and 125° F. water is being added to a previously empty bathtub, it is likely that the heater will be unnecessarily disabled.

Another disadvantage of prior art bathtub heater control systems is that power applied to the heating element is either fully on or fully off thereby making it more difficult to reach the desired temperature setting precisely, as the water temperature approaches the desired setting.

Still another disadvantage of the prior art is that, although the heating element may be deactivated when an unsafe condition is detected, the method of deactivation typically permits the user to re-activate the heating element such as by resetting the heater or by first removing all power from the heater and then re-applying power. While such features may seem convenient, they also invite disaster such as when an unsafe condition remains after re-applying power or resetting the heater and the user doesn't fully appreciate the danger of resuming heater operation without first obtaining professional servicing of the heater.

### SUMMARY OF THE INVENTION

The present invention provides a bathtub heater control apparatus which overcomes the noted deficiencies of the prior art. In a preferred embodiment disclosed herein by way of illustration of the underlying concepts and features thereof, it will be seen that the apparatus is configured as two distinct functional operations; i.e., nominal control and safety oversight. The nominal control portion of the apparatus responds to normal operating parameters to heat the bathtub water to the desired temperature and to maintain it there within defined limits of precision. A particularly unique aspect of this portion of the apparatus is proportionate temperature control. This feature employs heater power at less than full to achieve a fine degree of control at or near the desired temperature. By applying reduced power to the heater element as the water temperature approaches the desired setting, it is possible to reach the desired temperature more quickly and maintain it more accurately without on-off cycling due to over or under-correcting for environmental effects such as cool air temperature or the like.

The safety oversight portion of the invention has the unique feature of operating only while power is applied to the heating element. This feature avoids unnecessary deactivation of the heater or heating element due to false sensing of an unsafe condition such as when very hot water is being added to an empty or almost empty bathtub wherein the water temperature may temporarily exceed preset safety limits. This feature is particularly advantageous when combined with the safety aspect of the present invention relating to heater disablement in the event of a genuine unsafe condition. Specifically, the safety circuit of the illustrated embodiment preferably utilizes an internal fuse or circuit breaker requiring access to the heater itself before the heater can again be powered up. This makes it more likely that the actual cause of the safety problem will be located and resolved before the heater is re-activated.

Finally, the present invention employs separate temperature sensors for nominal control and safety. While the use of separate sensors, such as thermistors or the like, may not be unique, the invention's safety circuit requires that the temperatures sensed by these separate sensors be in agreement within a limited range. If they disagree, i.e., indicate different temperatures which are separated by a number of degrees beyond the limited range, that condition is recognized as a heater safety problem requiring that the heater be disabled based upon the assumption that at least one of the sensors must be malfunctioning.

### BRIEF DESCRIPTION OF THE DRAWINGS

The aforementioned objects and advantages of the present invention, as well as additional objects and advantages thereof, will be more fully understood hereinafter as a result of a detailed description of a preferred embodiment when taken in conjunction with the following drawings in which:

FIG. 1 is an overall flow chart diagram of a preferred embodiment of the invention;

FIG. 2 is a subroutine flow chart diagram of the heater element heating process of the preferred embodiment; and

FIG. 3 is a schematic circuit diagram of the preferred embodiment.

### DETAILED DESCRIPTION OF THE PREFERRED EMBODIMENT

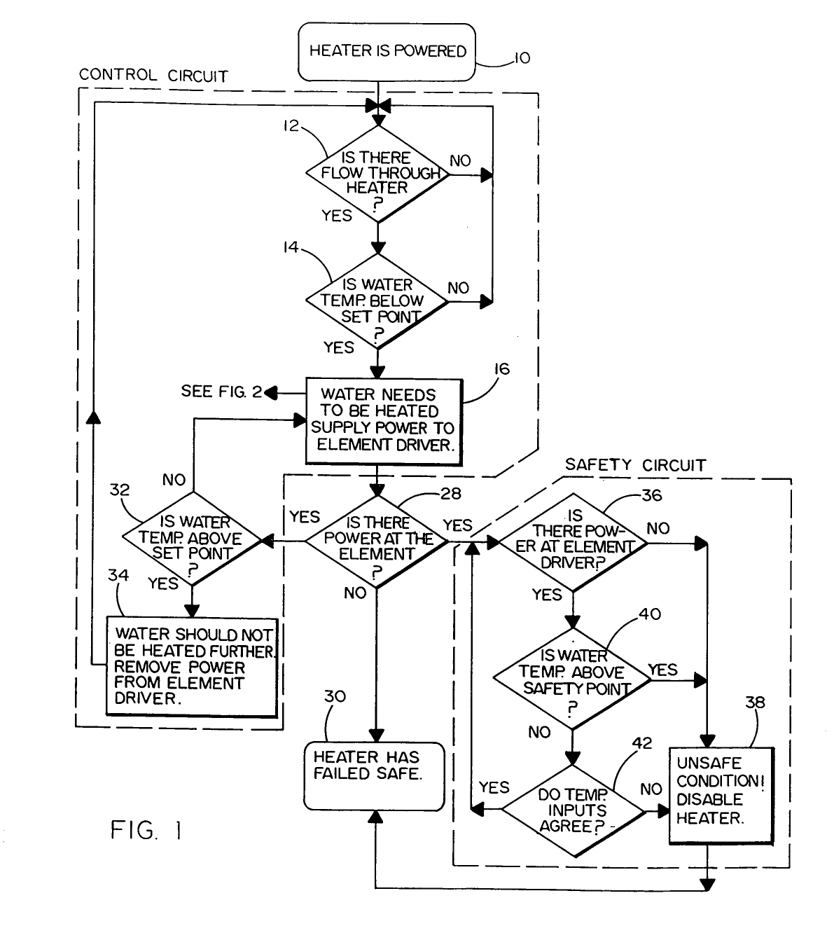

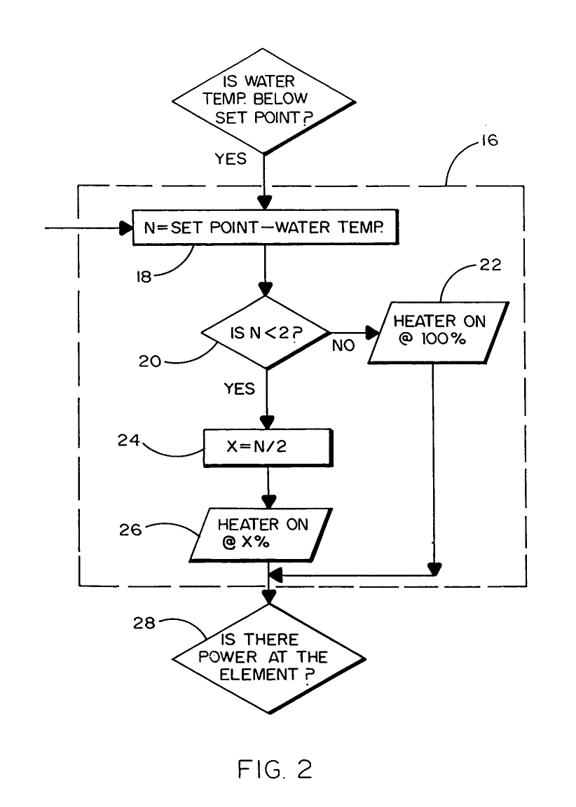

Referring to the accompanying drawings and initially to FIG. 1, it will be seen that the control circuit function begins with power being applied to the heater 10. The circuit then determines whether water is flowing through the heater in diamond 12. Only if the water is so flowing does the process continue. The circuit then determines whether the water temperature is below the set point in diamond 14. If it is not, there is no need to operate the heater at this time. If it is, the water temperature needs to be increased and power is applied to the heater element driver in step 16 by the subroutine A of FIG. 2.

Referring to FIG. 2, it will be seen that in step 18, a value “N” is determined as the difference between the set point and the measured water temperature. Then in diamond 20 it is determined whether the value N is less than a value Q° F. If it is not, power is applied to the heater element driver at 100% in step 22. If it is, then the heater element driver power percentage X is calculated in step 24 by dividing N by Q. Thus if Q=2N, then X=50%. Then in step 26 the heater element driver is powered up to X % thereby completing the subroutine A.

The process then determines whether power is being applied to the heating element in diamond 28. If it is not (despite the application of power to the element driver in step 16) then the heater has failed in a safe condition as indicated in box 30 wherein heater operation ceases. If there is power at the heating element, then the circuit next determines in diamond 32 whether the water temperature is above the set point. If it is not yet above the set point then the operation returns to step 16 and the subroutine of FIG. 2 to continue applying power to the heating element. In addition, if there is power at the heating element (and only if there is power at the heating element) the safety circuit begins to oversee the heater operation. As indicated in diamond 36 it is determined whether there is power at the heating element driver. If the answer is no, there is an unsafe condition (possible short circuit) because power has been found at the heating element, but not at the heating element driver. In this event, the heater is disabled in step 38 such as by blowing a fuse or tripping a circuit breaker internal to the heater. If the answer is yes, the safety circuit then determines in diamond 40 whether the water temperature is above the safety point. Typically, the safety point is a temperature that is several degrees above the set point, but not high enough to actually permit burning or otherwise injuring a user. If the water temperature is above this safety point, there is clearly an unsafe condition (malfunction in the nominal control circuit) and the heater is disabled in step 38. If the water temperature is below the safety point, the safety circuit then determines in diamond 42 whether the two distinct temperature sensors agree (within a limited range such as 3 or 4 degrees F.). If they do not agree, there is an unsafe condition (a malfunction in one of the temperature sensors) and the heater is disabled in step 38. If they do agree, the safety circuit operation continues as above in diamonds 36, 40 and 42 to maintain a constant vigil on heater operating safety.

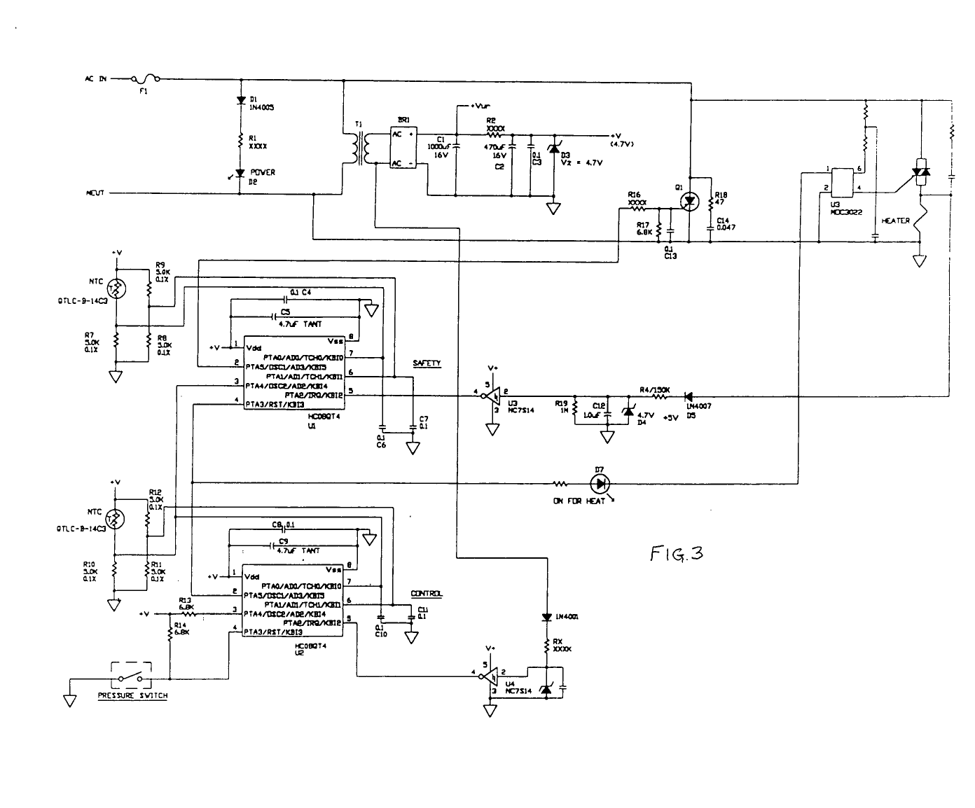

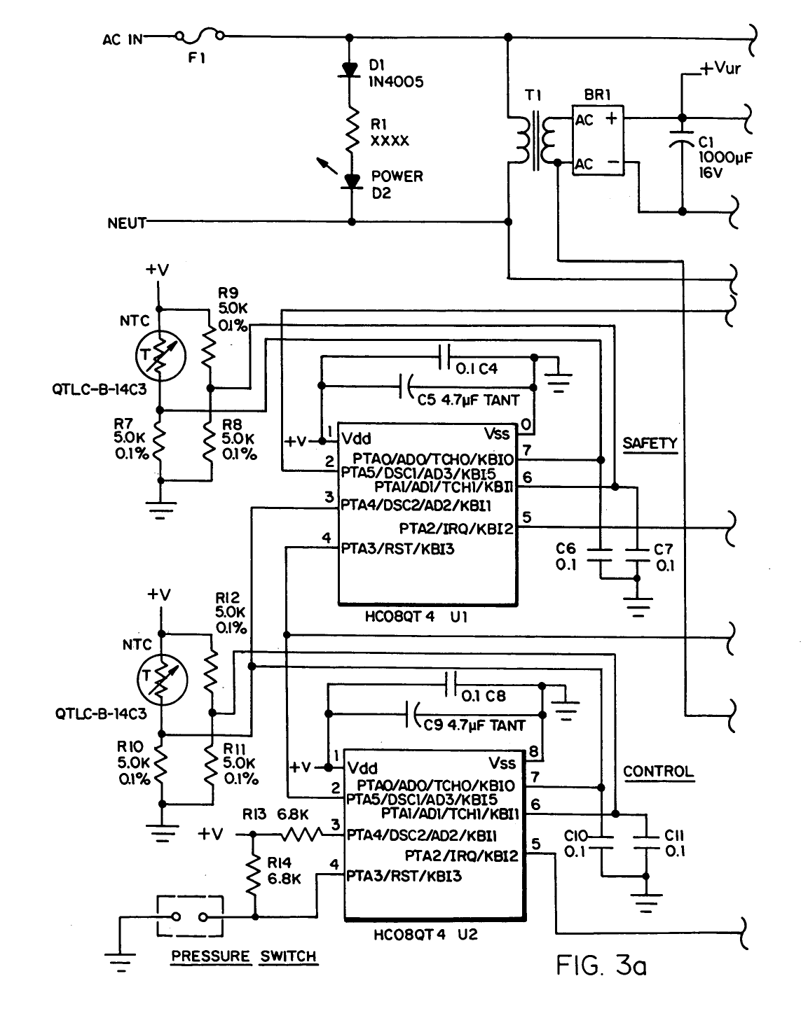

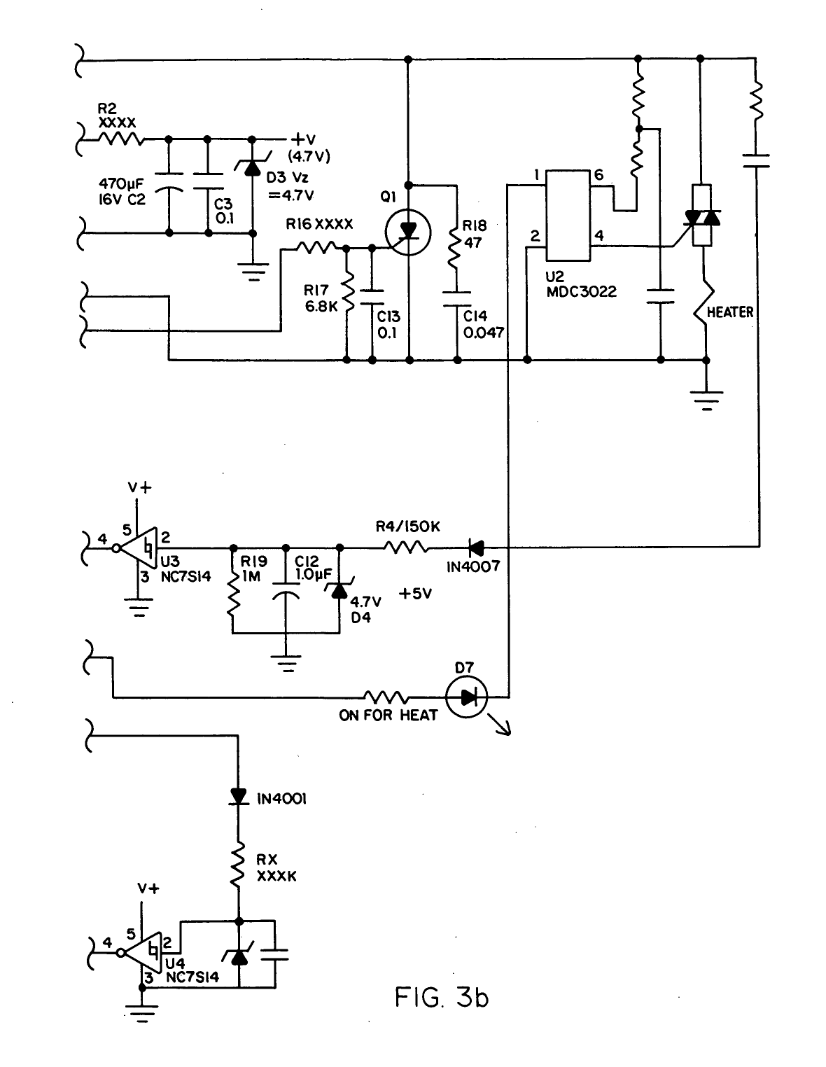

A schematic of the entire heater control circuit of a preferred embodiment is shown in FIG. 3. The schematic may be understood as having three sections. The upper section as seen in FIG. 3 is the heater element section in which AC power is applied to the heater element through a triac. The lower section of the schematic is the nominal control circuit section. It employs a control sensor bridge wherein the sensor is in direct contact with the pipe through which the water is flowing. This circuit section employs a control microprocessor U2 which controls the triac in response to the temperature as measured by the sensor bridge during normal operating conditions. The middle section of the schematic is the safety circuit section which employs another such safety sensor bridge and another such safety microprocessor U1.

The control sensor bridge is input to the safety microprocessor U1. This allows the safety microprocessor U1 to compare the two sensor bridges for carrying out the operation in diamond 42 of FIG. 1.

The safety microprocessor U1 receives an element power detect signal and an element driver power (triac) detect signal for carrying out the operations of diamonds 28 and 36 of FIG. 1.

Having thus disclosed a preferred embodiment of the present invention, it will be understood that various modifications and additions may be made with the benefit of the teaching herein. By way of example, the precise order of the steps and decisions shown in the flow chart of FIG. 1 may be altered without departing from the inventive concepts disclosed herein. Moreover, components used in the illustrated embodiment may be readily replaced by other components for carrying out the same functions. Accordingly, the scope hereof is to be limited only by the appended claims and their equivalents.

We claim:

1. A bathtub heater control apparatus for heating bathtub water which controls electrical power applied to a heating element and having a temperature sensor for tracking the water temperature; the apparatus comprising:
a proportionate heater element control circuit for applying full power to said element until said water temperature is within a selected range of a desired temperature and for applying a fraction of full power when said water temperature is within said range.

2. The bathtub heater control apparatus recited in claim 1 wherein said fraction is proportional to the difference between said water temperature and said desired temperature within said range.

3. A bathtub heater control apparatus for heating bathtub water and which controls electrical power applied to a heating element through a driver and having a first temperature sensor for tracking the water temperature: the apparatus comprising:
a safety circuit for disabling the bathtub heater if the water temperature reaches a defined high limit;
a detector for detecting whether electrical power is applied to said heating element; and
a device in said safety circuit for preventing said safety circuit from disabling said heater if the water temperature reaches said defined high limit without electrical power being applied to said heating element.

4. The bathtub heater control apparatus recited in claim 3 wherein said safety circuit is configured for disabling said bathtub heater in a manner in which requires access internal of said heater to re-enable said heater.

5. The apparatus recited in claim 3 wherein said safety circuit comprises a second temperature sensor for tracking the water temperature and wherein said safety circuit is configured for disabling the bathtub heater when said first and second temperature sensor indicate water temperatures that differ by greater than a selected number of degrees.

6. The bathtub heater control apparatus recited in claim 3 wherein said safety circuit comprises a detector for detecting if power is being applied to the heating element driver and wherein said safety circuit is configured for disabling said bathtub heater if power is detected at the heating element but is not detected at the heating element driver.

7. A method of controlling a bathtub heater having an electrical heating element in response to a temperature sensor for tracking the temperature of water in said bathtub; the method comprising the steps of:
applying full power to said heating element until said water temperature is within a selected range of a desired temperature; and
applying a fraction of full power when said water temperature is within said range.

8. The method recited in claim 7 further comprising the step of making said fraction proportional to the difference between said water temperature and said desired temperature within said range.

9. A method of controlling a bathtub heater having an electrical heating element and an element driver; the method comprising the steps of:
detecting whether electrical power is applied to said heating element; and
disabling said heater if the water temperature in said bathtub reaches a defined high limit if and only if electrical power is being applied to said heating element.

10. The method recited in claim 9 further comprising the steps of:
providing at least two temperature sensors at different locations for measuring water temperature;
detecting whether electrical power is applied to said heating element; and
disabling said heater if the at least two said temperature sensors disagree as to the water temperature by more than a determined number of degrees if and only if electrical power is being applied to said heating element.

11. The method recited in claim 9 further comprising the steps of:
detecting whether electrical power is applied to said heating element; and
detecting whether electrical power is applied to said heating element driver; and disabling said heater if power is not being applied to said heating element driver if and only if electrical power is being applied to said heating element.
